(19) United States
(12) Patent Application Publication
(10) Pub. No.: US 2017/0016707 A1
(43) Pub. Date: Jan. 19, 2017

(54) Thread Gauge and Method

(71) Applicant: World Concepts LLC, Wayne, PA (US)

(72) Inventor: Marcello Navarro, Springfield, PA (US)

(73) Assignee: World Concepts LLC, Wayne, PA (US)

(21) Appl. No.: 15/209,713

(22) Filed: Jul. 13, 2016

Related U.S. Application Data
(60) Provisional application No. 62/192,307, filed on Jul. 14, 2015.

(51) Int. Cl. G01B 3/48

(52) U.S. Cl. CPC G01B 3/48

(57) ABSTRACT

A three-roll thread gauge for measuring interior threads includes a fixed gauge roll and two movable gauge rolls. The motion of the two movable gauge rolls is constrained so that the interior angles of a triangle defined by the three gauge rolls are equal for each position of the first and second gauge rolls when the three gauge rolls are in engagement with an interior thread. The motion is constrained by reverse sine bars that limit the motion of first and second tables to which the first and second gauge rolls are attached.

### I. RELATED APPLICATIONS

This non-provisional patent application is entitled to priority from provisional application No. 62/192,307, by inventor Marcello Navarro, filed Jul. 14, 2015.

### II. BACKGROUND OF THE INVENTION

A. Field of the Invention

This application addresses improvements to a precision three-roll gauge for the measurement of threaded fasteners. The thread gauge includes one gauge roll that is fixed and two gauge rolls that move to engage the threaded fastener. In one aspect of the invention, a pair of reverse sine bars controls the motion of the two movable gauge rolls in the reverse direction to allow the thread gauge to measure internal threads. In a second aspect of the invention, the thread gauge of the invention includes spring plungers to prevent the uncontrolled collision of parts of the thread gauge during use so that the gauge is quiet in operation and has a high-quality feel in the hands of the metrologist. In a third aspect of the invention, a wear indicator on the surface of thread rolls allows the metrologist to visually determine when the thread rolls reach the limits of permissible wear needed to maintain accuracy. Another aspect of the invention is a method of providing, using or certifying set plugs or ring gauges including evaluating those gauges to determine a ‘functional value’ considering all of the imperfections in the thread of the set plug or ring gauge.

B. Statement of the Related Art

U.S. Pat. No. 6,868,618 to Marcello Navarro issued Mar. 22, 2005 is hereby incorporated by reference as if set forth in full herein. Navarro '618 teaches a three-roll thread gauge in which one of the rolls is fixed and two of the rolls are movable. The fixed roll is fixed with respect to a base. The first movable roll is attached to and moves with a first table. The second movable roll is attached to and moves with a second table. The first and second tables engage a carriage that features a cross-slide by which the first and second tables may advance or retreat together in a longitudinal direction with respect to the base either toward or away from the fixed roll. The first and second carriages may move with respect to the cross-slide of the carriage in a lateral direction toward or away from each other.

When the carriage is advanced toward the fixed gauge roll, the motion of the first movable thread roll is constrained in the lateral direction by a first sine bar fixed to the base and by a mating first adjustable strip attached to the first table. The first sine bar and first adjustable strip define an angle with respect to the longitudinal direction. The second sine bar and second table for the second movable gauge roll are a mirror image of the first sine bar and first table and operate in the same fashion.

In use, a male threaded object is placed in the space between the three gauge rolls. The carriage is advanced toward the fixed gauge roll. The first adjustable strip of the first table contacts the bearing surface of the first sine bar. The second adjustable strip of the second table contacts the bearing surface of the second sine bar. The adjustable strips and bearing surfaces, which are precision surfaces, are in sliding contact as the two movable gauge rolls advance toward the fixed gauge roll.

When the first and second adjustable strips are in contact with the bearing surfaces of the first and second sine bars, the three gauge rolls in combination define a triangle. The included angles of the triangle are equal for every position of the three gauge rolls, which is an advantage of the Navarro '618 gauge over the prior art because it allows the three-roll gauge to measure male threaded objects of different diameters without re-calibration. The Navarro '618 gauge allows measurement of external threads but does not measure internal threads.

When a metrologist is advancing the carriage toward the fixed gauge roll, the bearing surfaces of the first and second sine bars and the adjustable strips will collide. The surfaces of the carriage that engage the first and second tables also will collide with the corresponding surfaces of the tables both when the carriage is advanced toward the fixed gauge roll and when the carriage is withdrawn from the fixed gauge roll. The collisions may make a sound and a mechanical vibration that the metrologist may find less-than-desirable. If the metrologist is advancing or retracting the carriage manually, the metrologist may feel the impacts. Also, the sliding contact between the bearing surfaces and the adjustable strips may cause wear on the adjustable strips or bearing surface.

For precision measurement, tool wear will bias the measurements. Being able to detect when a maximum allowable wear has occurred will save time and money for the owner and operator of the measurement tool.

Users and manufacturers of threaded fasteners can readily determine the ‘pitch diameter’ of the threaded fasteners using conventional techniques. They can compare, both directly and statistically, the ‘pitch diameter’ of different fasteners measured at different times, by different metrologists, using different equipment and at different locations. The ‘pitch diameter’ does not determine whether two threaded fasteners will successfully mate and does not measure the accuracy of the threads of a fastener. Because of a lack of common language and common standards, the users and manufacturers of threaded fasteners are not readily able to directly and statistically compare the overall accuracy of the threaded fasteners and are not able to compare whether and to what extent the threaded fasteners will successfully mate with other threaded fasteners, particularly where the measurements are of different fasteners or by different metrologists or using different equipment or at different locations.

### III. BRIEF DESCRIPTION OF THE INVENTION

A. Reverse Sine Bar

The precision thread gauge has one stationary gauge roll and two movable gauge rolls. The thread gauge features a carriage configured to move along a longitudinal axis toward and away from the fixed gauge roll. The movable gauge rolls are attached to a first and a second table. The first and second table are moved by the carriage in the longitudinal direction and also are configured to move in the lateral direction with respect to the carriage.

The precision thread gauge is equipped with a first and a second reverse sine bar. The first reverse sine bar constrains the motion of the first table in the lateral direction when the carriage is moved in the longitudinal direction away from the fixed gauge roll. The second reverse sine bar is a mirror image of the first reverse sine bar. The first and second reverse sine bars cause the fixed gauge roll, the first gauge roll and the second gauge roll to define a triangle with constant included angles as the carriage is moved away from the fixed gauge roll. As a result, the precision thread gauge may be used to measure an internal thread, such as the internal thread of a ring gauge.

The precision thread gauge may have both sine bars and reverse sine bars, to allow both external and internal threads to be measured.

B. Spring-Loaded Contact Balls.

One or more spring-loaded contact balls are provided to cushion the impacts of the surfaces of the first and second tables and the corresponding surfaces of the carriage of the thread gauge. Spring-loaded contact balls also may be used to cushion the impacts of the sine bars or reverse sine bars and the corresponding surfaces of the first and second tables. The spring-loaded contact balls also may roll, resulting in a rolling engagement rather than a sliding engagement between the contacting surfaces, reducing wear of those surfaces. The spring and contact ball assembly may be installed on either of the colliding surfaces and the contact ball is proud of the surface to which it is installed.

When the carriage advances toward the fixed gauge roll, the contact ball at the interface between the carriage and the first table touches the opposing surface before the opposing surfaces of the carriage and first and second tables touch. The spring rate of the springs loading the contact balls is selected to cushion the impact between the surfaces, which reduces noise from that impact and imparts a high-quality feel to the gauge, improving the aesthetic experience of using the gauge.

Spring-loaded contact balls also may be installed at the interface between the first and second sine bars or the first and second reverse sine bars and the corresponding surfaces of the first and second tables. The spring rate of the spring loading the contact balls also is selected so that the force required to compress the spring so that corresponding surfaces touch is greater than the force required to move the table in the lateral direction. In use, the bearing surface and the adjustable strip are separated by the contact ball as the table is advancing toward the fixed gauge roll, or, for a thread gauge equipped with reverse sine bars, as the table retreats from the fixed gauge roll. The contact balls roll in response to the relative motion of the contact ball and the opposing surface. When the movable gauge rolls touch the object to be measured, motion of the tables with respect to the fixed roll ceases and an increase in force applied to the carriage overcomes the force of the spring and pushes the adjustable strip against the bearing surface.

The result is a rolling contact and not a sliding contact between the corresponding surfaces until the movable gauge rolls contact the object to be measured. The rolling contact results in less wear and fewer adjustments to the gauge.

C. Gauge Roll Wear Indicator

The rolls gauges may be provided with an indicator layer of a contrasting color to the underlying substrate. For example, the gauge roll may be manufactured to be the minimum diameter that will achieve acceptable measurement accuracy for the gauge. The gauge roll then may be coated with a wear indicator of a contrasting color, for example titanium nitride, titanium carbon nitride or titanium aluminum nitride. Titanium nitride can offer a wear layer of a gold color, while titanium carbon nitride and titanium aluminum nitride can offer colors ranging from gray to black.

The wear indicator may coat the gauge roll by chemical vapor deposition or physical vapor deposition, vacuum deposition, sputtering deposition, thin-film deposition, dip-coating, painting, plating, anodizing or by any other coating technology suitable for the substrate from which the structure of the gauge roll is composed and for the coating. The gauge roll may be coated with multiple contrasting layers. The final dimensions of the completed gauge rolls are selected so that the gauge roll can be used to make adequately accurate measurements.

In use, the metrologist will observe the surface of the gauge rolls at the location where the gauge rolls contact the object to be measured. If the metrologist observes no change in color of the gauge roll at that location, then the metrologist can conclude that the gauge roll is not so worn as to prevent accurate measurement. If the metrologist observes the contrasting color of the substrate or of another layer on which the wear layer is deposited, then the metrologist will conclude that the gauge roll has worn. If the metrologist observes the color indicating that the gauge roll has worn to the acceptable limits, then the metrologist will conclude that the thread gauge needs maintenance.

The gauge roll may be manufactured with a number of reference locations on the gauge roll that will produce accurate measurements. The reference locations may be demarcated by the structure of the gauge roll, as by grooves or fillets in the surface of the gauge roll, or by the color of the reference portions, or by keys or other shapes limiting the mounting options for the gauge roll or by indicia marked on the gauge roll.

When the metrologist determines that a location on the gauge roll is worn and requires service, the metrologist may loosen the fastener attaching the gauge roll to the gauge and rotate the gauge roll to expose an un-worn reference location on the gauge roll. If all of the wear locations on the gauge roll are worn, the metrologist will remove and replace the gauge roll. The metrologist will tighten the fastener holding the gauge roll in place. The gauge is then ready for further measurement.

D. Method and System of Functional Value Measurement

The invention is also a method and system of providing set plugs or ring gauges certified with a functional value of the set plug or ring gauge. The set plug or ring gauges may be marked with the functional value. The invention is also a method of checking and inspecting threaded fasteners using set plug or ring gauges certified or marked with a functional value.

Any manufacturer of objects that are held together by threaded fasteners likely inspects those threaded fasteners to determine whether to accept or to reject the fasteners. Any manufacturer of threaded fasteners also inspects its products to monitor the production process and to detect and predict, for example, worn tooling interfering with production quality. In any inspection of a male threaded fastener of a given lead, thread profile and straightness, there are two considerations: (1) that the male threaded fastener is adequately large so that the fastener is strong enough not to fail in service, and (2) that the male threaded fastener is adequately small so that the male threaded fastener will fit in a corresponding female threaded fastener.

The ‘pitch diameter’ is a measurement of the diameter of an imaginary cylinder at which the length of the thread and of the groove between adjacent threads in the longitudinal direction is equal. The ‘pitch diameter’ therefore is an indication of how much metal or other solid material is in a threaded fastener and thus whether the threaded fastener is adequately strong to avoid failure of the fastener in service.

The pitch diameter is measured at three points on the fastener—with two points on one side and one point opposite the other two, and does not measure the thread as a whole. The pitch diameter measurement ignores any imperfections in the thread. Since every threaded fastener has imperfections, the ‘pitch diameter’ represents the lower limit of the size of a male fastener. If the pitch diameter of a male threaded fastener is too small, the male threaded fastener may be able to mate with the corresponding female threaded fastener, but the male threaded fastener or the thread connection or both will be weak and may fail in service. The above discussion applies equally to female threaded fasteners, but in reverse. For a female threaded fastener, the ‘pitch diameter’ measures the theoretical maximum size of the opening in the fastener.

The ‘functional value’ of a fastener is the effective diameter of the overall threaded portion of the fastener, including all defects in the threads. The ‘functional value’ is a measure of whether one threaded fastener will actually be able to mate with another threaded fastener. Because every thread has defects, the ‘functional value’ of a male threaded fastener is always larger than the ‘pitch diameter.’ The ‘functional value’ of a female threaded fastener is always smaller than the ‘pitch diameter’ of the female threaded fastener. The closer the measured ‘functional value’ to the ‘pitch diameter,’ the fewer the defects in the thread and hence the more accurate the thread. In general, an accurate thread will be easier to assemble and disassemble and stronger in service than an inaccurate thread. If the functional value of a male threaded fastener is too large and the functional value of a female threaded fastener too small, then the threaded fasteners will not mate at all. Set plugs and ring gauges used to calibrate other thread gauges are calibrated and marked for pitch diameter and are not calibrated or marked for ‘functional value.’

The Navarro '618 gauge or the improved gauge described above and equipped with full thread gauge rolls indicates the ‘functional value’ of the plug or ring gauges, which aggregates all of the errors of the thread to be measured. The ‘functional value’ of a set plug accurately indicates whether the female thread measured by the set plug will effectively mate with a male thread having a consistent ‘functional value.’

For the method of the invention, a gauge user may provide a set plug or ring gauge to a gauge service provider. The gauge service provider will measure the set plug or ring gauge with the Navarro '618 gauge, with the improved gauge addressed above, or with another gauge that measures the functional diameter of the set plug or ring gauge. The measurement obtained is the functional value of the set plug or ring gauge. The service provider will provide a certificate certifying the measured functional value of the set plug or ring gauge. Optionally, the service provider may mark the set plug or ring gauge with the measured functional value.

In use, the user of the set plug or ring gauge may calibrate another thread gauge, such as the Navarro '618 gauge, a tri-roll gauge, or other suitable gauge using the certified or marked set plug or ring gauge. The calibrated thread gauge is then configured to measure the functional value of a threaded fastener. To inspect a threaded fastener, the user will measure the pitch diameter of the thread in the conventional manner and will measure the functional diameter of the thread using the gauge that has been calibrated to measure functional value. By comparing the measured pitch diameter and functional value, the user can measure a degree of defectiveness and hence measure the accuracy of the threaded fastener.

Because the functional value thread gauges are calibrated to a common reference standard, the user can compare, both directly and statistically, the measured functional values and the accuracy of the threaded fastener to other measurements of functional value and accuracy, including measurements made by other persons, at other times, at other locations, on other equipment, and testing other threaded fasteners. The user of the thread fastener, the manufacturer of the threaded fastener, testing laboratories, standards setting bodies, and anyone else to whom threaded fasteners are important can use the common language and common measurement to determine whether threaded fasteners will fit together and how accurate the threads of the threaded fasteners are.

In the absence of the Invention; that is, without common, repeatable functional value testing, the user and manufacturer of the threaded fastener or other interested party cannot perform reliable direct or statistical evaluations of the fasteners. The result is partial blindness and lack of process control on the part of the user of the threaded fastener and the manufacturer of the threaded fastener—they are less able to detect approaching failure, say, due to worn tooling, before that failure occurs.

### IV. BRIEF DESCRIPTION OF THE FIGURES

FIG. 1 is a perspective view of the gauge having reverse sine bars.

FIG. 2 is a plan view of the gauge having reverse sine bars.

FIG. 3 is a plan view of the gauge having reverse sine bars.

FIG. 4 is a detail section view of a spring-loaded contact ball.

FIG. 5 is a cutaway view of the spring loaded contact balls.

FIG. 6 is a section view of a gauge roll with a wear coating.

FIG. 7 is a magnified detail of a gauge roll with a wear coating.

FIG. 8 is a top view of a gauge roll.

FIG. 9 is a top view of a gauge roll.

FIG. 10 is a flow chart of a method of functional value measurement.

FIG. 11 is a flow chart of a method of use of the functional value reference.

FIG. 12 is a plan view of the thread gauge advancing to measure an internal thread.

FIG. 13 is a plan view of the thread gauge measuring an internal thread.

### V. DESCRIPTION OF AN EMBODIMENT

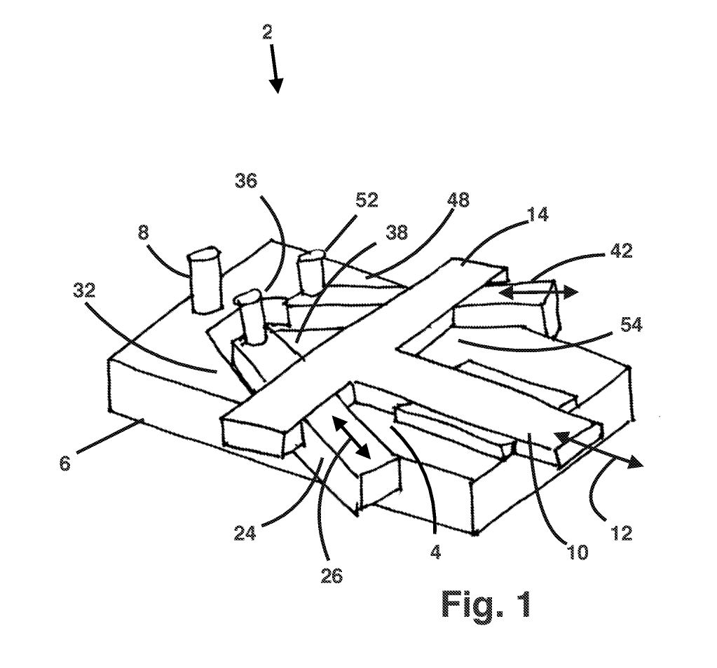

FIGS. 1-3 and 12-13 illustrate a three-roll gauge 2 having reverse sine bars 4 and capable of measuring a female thread, such as a ring gauge, by holding one gauge roll stationary and simultaneously moving two movable gauge rolls until all three gauge rolls contact the object to be measured.

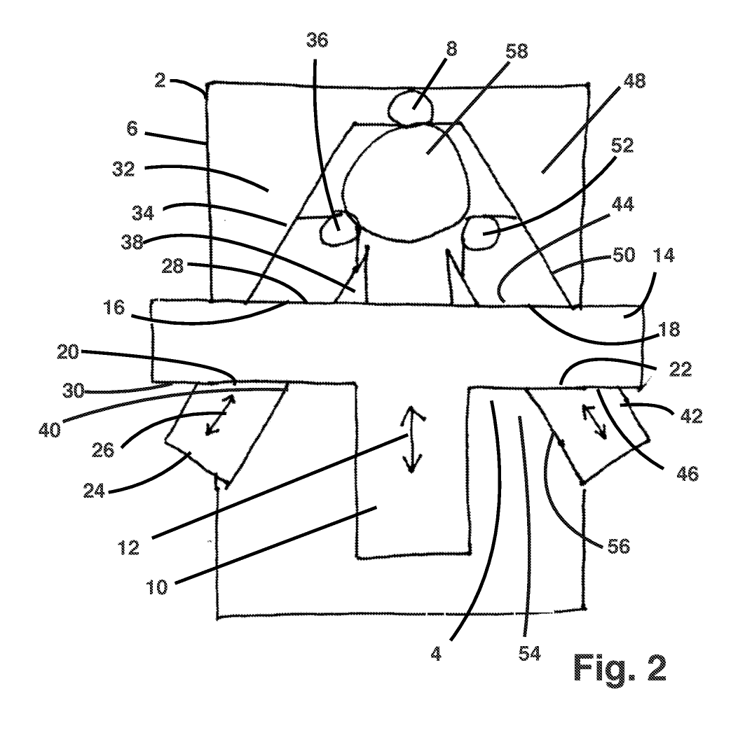

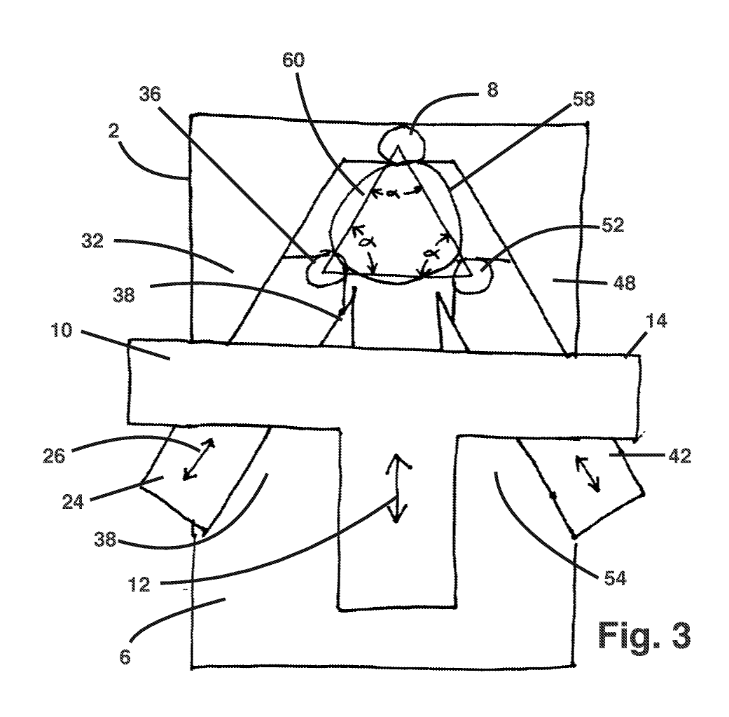

FIG. 1 is a perspective view of an example gauge 2 and FIGS. 2 and 3 are plan views of the gauge 2. The gauge 2 includes a base 6. A fixed gauge roll 8 is attached to the base 6 and is stationary with respect to the base 6. A carriage 10 is configured to move in a longitudinal direction 12 both toward and away from the fixed gauge roll 8. The motion of carriage 10 is constrained so that carriage 10 does not move laterally with respect to the base 10. The carriage 10 defines a slide 14. The slide 14 defines a first advancing contact surface 16 and a second advancing contact surface 18. The slide also defines a first retreating contact surface 20 and a second retreating contact surface 22.

A first table 24 is supported by the base 6. The first table is configured to move with respect to the base 6 in the first direction 26, both toward and away from the fixed gauge roll 8. The first table 24 defines a first table advancing contact surface 28 that engages the carriage first advancing contact surface 16 when the carriage 10 moves toward the fixed gauge roll 8. The first table 24 defines a first table retreating carriage contact surface 30 that engages the carriage first retreating contact surface 20 when the carriage is moving away from the fixed gauge roll 8.

When the carriage 10 is advancing toward the fixed gauge roll 8, the engagement between the first table advancing contact surface 28 and the carriage first advancing contact surface 16 causes the first table 24 also to move in the longitudinal direction 12. The motion of the first table 24 is constrained laterally when the first table 24 is advancing by the first sine bar 32. The first sine bar contact surface 34 engages the first table 24 when the carriage 10 and the first table 24 are advancing, forcing the first table 24 to move laterally with respect to the longitudinal axis 12 as the first table 24 advances. The first movable gauge roll 36 is attached to the first table 24 and moves with the first table 24.

When the carriage 10 moves in the longitudinal direction 12 away from the fixed gauge roll 8, the carriage first retreating contact surface 20 engages the first table retreating contact surface 30, forcing the first table 24 also to move in the longitudinal direction 12. When retreating from the fixed gauge roll 8, the lateral motion of the first table 24 is constrained by the first reverse sine bar 38. The first reverse sine bar contact surface 40 contacts the first table 24, forcing the first table 24 to move laterally as the first table 24 retreats in the longitudinal direction 12 away from the fixed gauge roll 12.

The second table 42 is a mirror image of the first table 24 and the second table 42 moves in a manner identical to the first table 24. When the carriage 10 is advancing toward the fixed gauge roll 8, the engagement between the second table advancing contact surface 44 and the carriage second advancing contact surface 20 causes the second table 26 also to move in longitudinal direction 12. The motion of the second table 42 is constrained laterally when the second table 42 is advancing by the second sine bar 48. The second sine bar contact surface 50 engages the second table 42 when the carriage 10 and the second table 42 are advancing, forcing the second table 42 to move laterally with respect to the longitudinal axis 12 as the second table 42 advances. The second movable gauge roll 52 is attached to the second table 42 and moves with the second table 42.

When the carriage 10 is moving in the longitudinal direction 12 away from the fixed gauge roll 8, the carriage second retreating contact surface 22 engages the second table retreating contact surface 46, forcing the second table 42 also to move in the longitudinal direction 12. When retreating from the fixed gauge roll 8, the lateral motion of the second table 42 is constrained by the second reverse sine bar 54. The second reverse sine bar contact surface 56 contacts the second table 42, forcing the second table 42 to move laterally as the second table 42 retreats in the longitudinal direction 12 away from the fixed gauge roll 12.

In use, and as shown by FIG. 2, an object to be measured 58 that defines a male thread, such as a plug gauge, is placed between the three gauge rolls 8, 36, 52 and the carriage 10 is advanced toward the fixed gauge roll 8 until all three gauge rolls 8, 36, 52 contact the object to be measured 58. The position of the carriage 10 in the longitudinal direction 12 defines the measurement. To measure an object that defines a female thread, such as a ring gauge, the object is placed over the three gauge rolls 8, 36, 52 and the carriage 10 is moved in the longitudinal direction 12 away from the fixed gauge roll 8 until all three gauge rolls 8, 36, 52 engage the interior of the female thread. The longitudinal location of the carriage 10 defines the measurement. Where the gauge rolls 8, 36, 52 are full-form threads, the measurement will be the functional value of the measured object 58.

FIG. 3 illustrates that the first and second sine bars 32, 48, the first and second reverse sine bars 38, 54 and the first and second tables 24, 54 are configured so that the first and second movable gauge rolls 36, 52 in cooperation with the fixed gauge roll 8 define a triangle 60, preferably an equilateral triangle 60 have equal included angles α, for every location of the first and second movable gauge rolls 36, 52, both when the first and second movable gauge rolls 36, 52 are advancing against a male object to be measured 58 and when the first and second movable gauge rolls 36, 52 are retreating against a female object to be measured.

The gauge 2 may dispense with the first and second sine bars 32, 48 while retaining the first and second reverse sine bars 38, 54, in which event the gauge 2 is suitable for measurement only of female threads, such as a ring gauge.

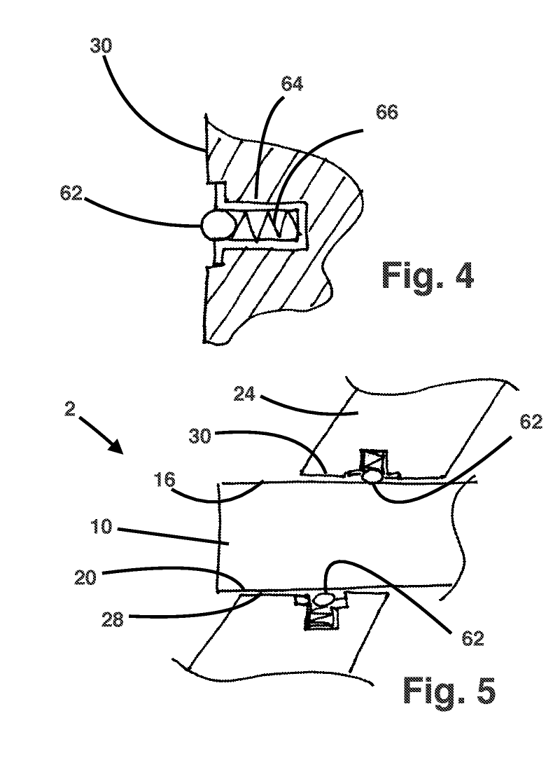

FIGS. 4 and 5 illustrate the use of spring-loaded contact balls 62. The spring loaded contact balls 62 include a housing 64 and a spring 66. The contact balls 62 may be composed of a resilient material, such as nylon, or may be composed of a hard material, such as stainless steel. As shown by FIG. 5, the spring-loaded contact balls 62 may be inset into one or more of the contact surfaces of the gauge 2. For example, the contact balls 62 may be inset into the carriage first advancing contact surface 16 or the corresponding first table advancing contact surface 28. The contact balls 62 may be inserted into the carriage first retreating contact surface 20 or the corresponding first table retreating contact surface 30. The contact balls may be inset into any of the surfaces of the gauge 2 that make contact, as described above, other than the contact between a gauge roll 8, 36, 52 and an object to be measured 58. The spring loaded contact balls 62 may roll when surfaces make a sliding contact, such as the surfaces of the carriage 10 and the corresponding surfaces of the tables 24, 42, or such as the surfaces of the tables 24, 42 and the corresponding surfaces of the sine bars 32, 48 or reverse sine bars 38, 54.

The spring-loaded contact balls 62 provide a perception of high-quality to the metrologist because the spring-loaded contact balls extend beyond the surface to which the contact ball 62 is inset, cushioning the blow when one contact surface collides with another and reducing any sound caused by the impact.

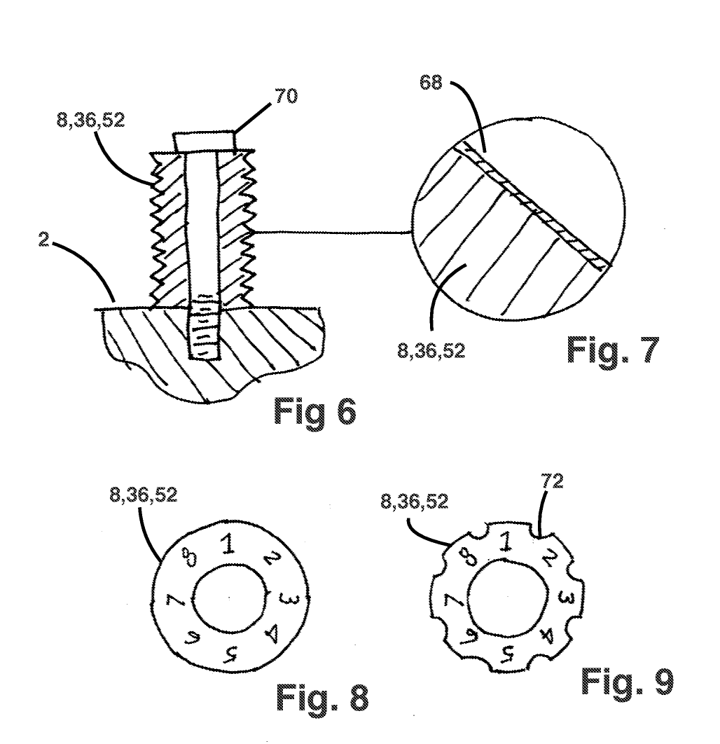

FIGS. 6 through 9 illustrate a gauge roll 8, 36, 52 having a wear-indicating coating 68. FIG. 6 illustrates that the gauge roll 8, 36, 52 is secured to the gauge 2 by a bolt 70 and is movable and replaceable. FIG. 7 is a magnified detail of FIG. 6, showing that a uniform layer of the coating 68 appears on the surface of the gauge roll 8, 36, 52. The coating may be a thin layer of titanium nitride or any suitable material that has a contrasting color to the color of the material defining the remainder of the gauge roll 8, 36, 52. The coating 68 may be composed of a plurality of layers, each having a contrasting color. As the gauge roll 8, 36, 52 is used, the coating 68 will wear until the color of the material underlying the coating 68 is visible to a user.

FIGS. 8 and 9 are end views of the gauge roll 8, 36, 52. The gauge roll 8, 36, 52 may indicate a plurality of locations around the circumference of the gauge roll 8, 36, 52 that may be used for thread measurement. When one location becomes worn, the user will loosen the bolt 70 securing the gauge roll 8, 36, 52 and rotate the gauge roll 8, 36, 52 until an un-worn location on the gauge roll 8, 36, 52 is exposed. The user then would tighten the bolt 70 and calibrate the gauge 2. As shown by FIG. 9, the gauge roll 8, 36, 52 may include grooves 72, fillets or other physical features limiting the locations on the gauge roll 8, 36, 52 available for use. The possible locations may be numbered or otherwise indicated by a mark on the gauge roll 8, 36, 52. In the examples of FIGS. 8 and 9, eight locations are provided, but any number of locations may be indicated. The permissible locations on the gauge roll 8, 36, 52 may be indicated by color; for example, by having the coating 68 appear only on specified portions of the gauge roll 8, 36, 52.

The possible orientations of the gauge roll 8, 36, 52 on the gauge 2 may be limited by the physical characteristics of the gauge roll 8, 36, 52 and of the mounting location for the gauge roll 8, 36, 52 or both. For example, the mounting location may include one or more upright pins that engage slots 72 and, in the example of FIG. 9, prevent the gauge roll 8, 36, 52 from being mounted to the gauge 2 in any other than the eight prescribed orientations. Alternatively, the gauge roll 8, 46, 52 and mounting location may include mating keys and slots or any other physical features such as mating pins and holes that limit the possible orientations of the gauge roll 8, 36, 52 on the gauge 2.

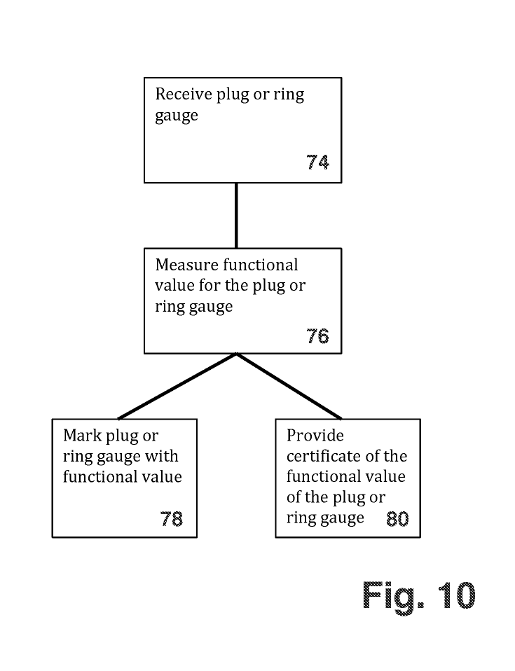

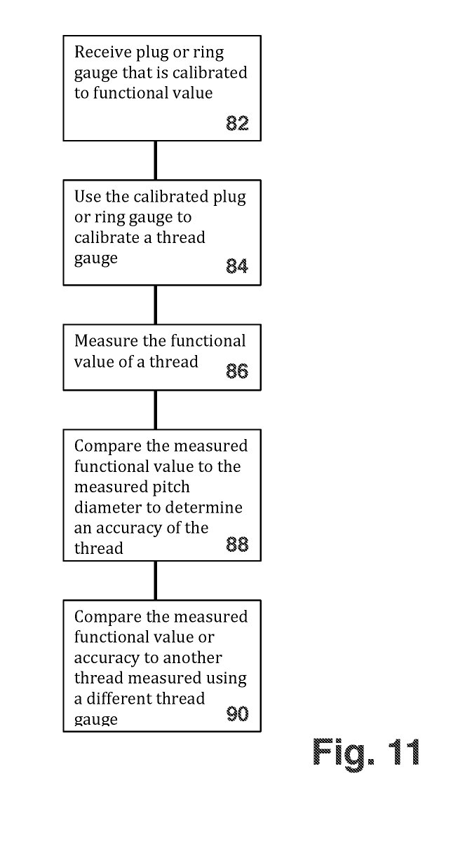

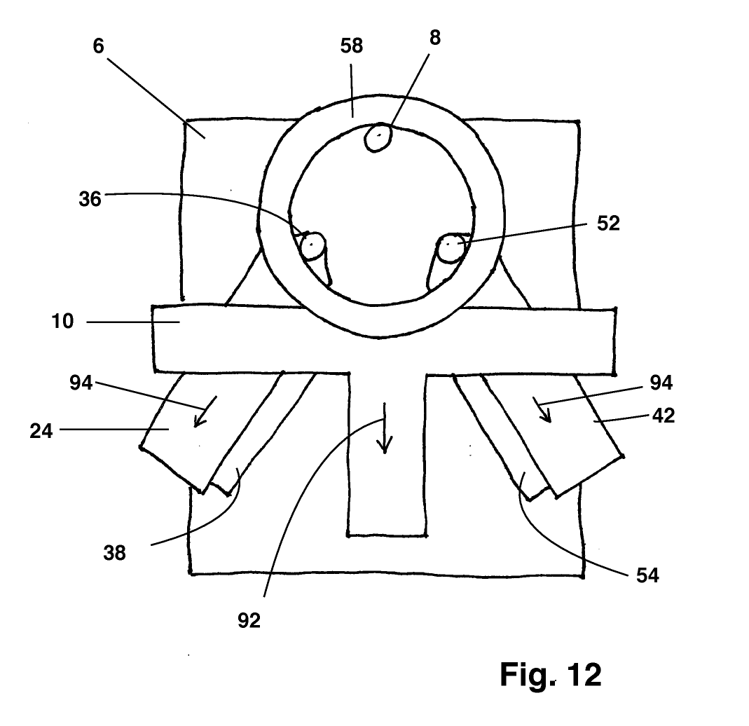

FIGS. 10 and 11 illustrate methods of using a functional value to evaluate threaded objects, such as fasteners. FIG. 10 provides the steps to be followed by a service provider. In step 74, the service provider receives a gauge to be measured, such as a set plug or ring gauge, from a user. In step 76, the service provider measures the functional value, as defined above, for the set plug or ring gauge to be measured. In step 78, the service provider marks the set plug or ring gauge with the measured functional value. In alternative step 80, the service provider provides a certificate to the user of the functional value of the set plug or ring gauge.

FIG. 11 illustrates the use of the set plug or ring gauge measured for functional value. In step 82 the user of the set plug or ring gauge receives a set plug or ring gauge that has been measured for functional value. The user calibrates a tri-roll gauge, the Navarro '618 gauge or the improved gauge described above to the functional value of the measured set plug or ring gauge in step 84. From step 86, the user will use the calibrated tri-roll gauge Navarro '618 gauge or improved gauge described above to measure the functional value of a thread. For step 88, the user compares the measured functional value of the thread with the measured pitch diameter for the same thread to determine an accuracy of the thread. With the pitch diameter and functional diameter, the user has enough information to make a determination as to whether the thread is of an acceptable dimensional quality. The user can compare the results to the measurement of functional value and thread accuracy, as indicated by step 90, to the results of other measurements made by other person, on other thread gauges and at other times. The user may make meaningful statistical evaluations of the functional value and accuracy of different threads, of threads measured using different tools, of threads measured by different metrologists and at different locations.

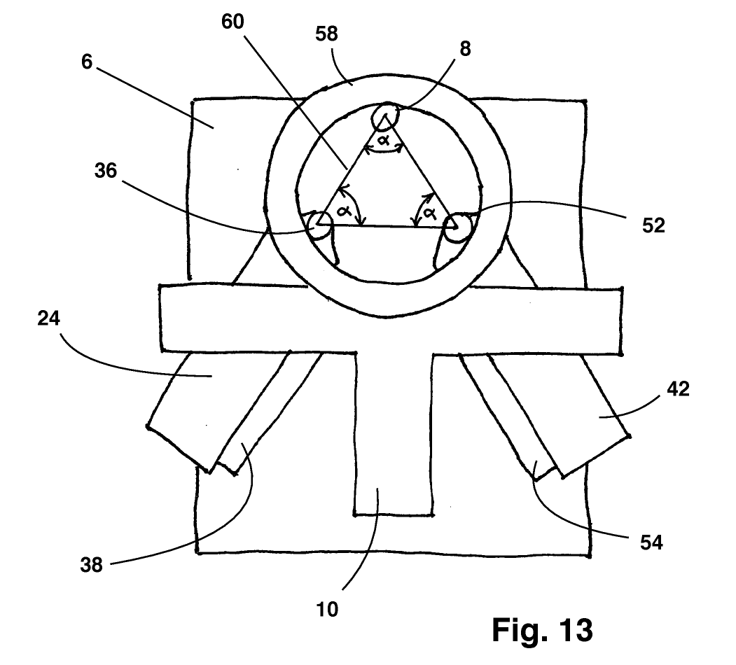

FIGS. 12 and 13 illustrate the thread gauge 2 where the object to be measured 58 is an internal thread, such as a ring gauge. As shown by FIG. 12, the object to be measured 58 is placed where the gauge rolls 8, 36, 52 will contact the internal threads. The carriage 10 is urged away from the fixed gauge roll 8 in the longitudinal direction indicated by arrow 92. The carriage 10 is in a sliding engagement with the first and second tables 24, 42. The motion of the carriage 10 causes the tables 24, 42 to move in the direction indicated by arrows 94. The motion of the first table 24, and hence the motion of the first gauge roll 36, away from the fixed gauge roll 8 is constrained by the first reverse sine bar 38. The motion of the second table 42 away from the fixed gauge roll 8 is constrained by the second reverse sine bar 54. The carriage 10 is moved in the longitudinal direction 92 away from the fixed gauge roll 8 until the first, second and fixed gauge rolls 8, 36, 52 engage the internal threads of the object to be measured 58.

FIG. 13 shows the gauge rolls 8, 36, 52 in engagement with the internal threads of the object to be measured 58. The gauge rolls 8, 36, 52 define a triangle 60 for which the included angles α are equal for any diameter of the object to be measured 58 within the range of measurement of the thread gauge. Although FIG. 13 shows the triangle 60 as defined by the center of the gauge rolls 8, 36, 52, the locations on the gauge rolls 8, 36, 52 that contact the internal threads of the object to be measured 58 also define the triangle 60 with equal included angles α.

As shown by FIGS. 12 and 13 and unlike the Navarro '618 patent, a single motion of the carriage 10 in the direction 92 of FIG. 12 will move both tables 24, 42 into engagement with an interior thread of the object to be measured 58 while maintaining equal included angles α for the triangle 60 defined by the three gauge rolls 8, 36, 52.

### LIST OF NUMBERED ELEMENTS FROM THE DRAWINGS AND SPECIFICATION

2 gauge
4 reverse sine bars
6 base
8 fixed gauge roll
10 carriage
12 longitudinal direction
14 slide of the carriage
16 carriage first advancing contact surface
18 carriage second advancing contact surface
20 carriage first retreating contact surface
22 carriage second retreating contact surface
24 first table
26 first direction
28 first table advancing contact surface
30 first table retreating contact surface
32 first sine bar
34 first sine bar contact surface
36 first movable gauge roll
38 first reverse sine bar
40 first reverse sine bar contact surface
42 second table
44 second table advancing contact surface
46 second table retreating contact surface
48 second sine bar
50 second sine bar contact surface
52 second movable gauge roll
54 second reverse sine bar
56 second reverse sine bar contact surface
58 object to be measured
60 triangle
62 spring-loaded contact ball
64 housing 64
66 spring
68 coating
70 bolt
72 groove
74 receive plug or ring gauge
76 measure functional value
78 mark plug or ring gauge with functional value
80 provide certificate of functional value
82 receive measured gauge
84 use measured gauge to calibrate thread gauge
86 measure functional value of a thread
88 compare measured functional value to pitch diameter of the thread to determine accuracy
90 compare accuracy of the thread to the accuracy of other threads measured
92 using different equipment
94 direction of motion of the carriage
94 direction of motion of the first and second tables

I claim:

1. An apparatus for measuring an interior thread having any of a plurality of diameters, the apparatus comprising:
a. a base;
b. a fixed gauge roll, a first gauge roll and a second gauge roll, said fixed gauge roll being attached to said base, said fixed gauge roll, said first gauge roll and said second gauge roll in combination defining a triangle, said triangle having included angles;
c. a carriage, said carriage being movable in a direction away from said fixed gauge roll;
d. a first table, said first gauge roll being attached to said first table, said first table being in slidable engagement with said carriage, said carriage being configured to urge said first table away from said fixed gauge roll and into engagement with the interior thread when said carriage is moved in said direction away from said fixed gauge roll;
e. a second table, said second gauge roll being attached to said second table, said second table being in slidable engagement with said carriage, said carriage being configured to urge said second table away from said fixed gauge roll and into engagement with the interior thread when said carriage is moved in said direction away from said fixed gauge roll;
f. a first reverse sine bar and a second reverse sine bar, said first reverse sine bar constraining a motion of said first table away from said fixed gauge roll, said second reverse sine bar constraining said motion of said second table away from said fixed gauge roll, said first and second reverse sine bars limiting said motion of said first and second tables when said carriage is urging said first and second tables away from said fixed gauge roll so that said included angles of said triangle are equal when said fixed gauge roll, said first gauge roll and said second gauge roll are urged into said engagement with the interior thread for each of the plurality of diameters of the interior thread.
